(19) United States
(12) Patent Application Publication
(10) Pub. No.: US 2017/0312818 A1
(43) Pub. Date: Nov. 2, 2017

(54) METHOD FOR MANUFACTURING CYLINDER BLOCK FOR VEHICLE

(71) Applicant: Hyundai Motor Company, Seoul (KR)

(72) Inventor: Seong Guk Son, Seoul (KR)

(21) Appl. No.: 15/249,682

(22) Filed: Aug. 29, 2016

(30) Foreign Application Priority Data
Apr. 28, 2016 (KR) 10-2016-0052048

(51) Int. Cl. B22D 27/18; F02F 7/00; B22D 15/02; B22C 9/24; B22D 25/02; B22D 21/00; F02F 1/00

(52) U.S. Cl. CPC B22D 27/18; F02F 1/004; F02F 7/0095; F02F 7/0085; B22C 9/24; B22D 25/02; B22D 21/007; B22D 15/02; F02F 2200/06

(57) ABSTRACT

A method for manufacturing a cylinder block for a vehicle integrates a cylinder liner with the cylinder block. The method includes steps of: preparing a molded material having a cylinder liner shape; fixing the prepared molded material to an inside of a mold for the cylinder block; and casting the cylinder block integrated with the molded material by injecting casting molten metal for the cylinder block into the mold for the cylinder block to which the molded material is fixed.

### CROSS REFERENCE TO RELATED APPLICATION

The present application claims under 35 U.S.C. §119(a) the benefit of Korean Patent Application No. 10-2016-0052048, filed on Apr. 28, 2016, the entire contents of which are incorporated by reference herein.

### BACKGROUND

### 1. Technical Field

The present invention relates to a method for manufacturing a cylinder block for a vehicle, and more particularly, to a method for manufacturing a cylinder block in which a cylinder liner and the cylinder block are integrated.

### 2. Description of the Related Art

Generally, a cylinder block is a core part of an engine of cast iron or an aluminum alloy. In the past, cast iron has been used, because it is suitable for casting and mechanical working, and is low cost. In recent years, however, the aluminum alloy has been mostly used for weight reduction.

Preferably, the cylinder block is formed so that one casting includes a plurality of cylinders. In the case of the cylinder block of the aluminum alloy, a cylinder liner is generally press fitted or injected in a cylindrical hole forming the cylinders. Here, the cylinder liner is a thin cylinder disposed on an inner surface of the cylinder to form a slide surface having wear resistance. Generally, the cylinder liner is formed by casting steel and then precisely polishing the steel.

The cylinder block of the aluminum alloy has a problem in that the cylinder block and the cylinder liner are separately manufactured, and then the cylinder liner is press fitted or injected in the cylinder block, and therefore the number of manufacturing processes is increased. In particular, a method for manufacturing an engine block by first sintering a powder-type molded material for a cylinder liner obtained by pressing mixed raw material powder such as metal powder and then injecting a sintered material into the aluminum alloy has been proposed. However, the method has a problem in that press molding is performed on the powder-type molded material for the cylinder liner and then a sintering process is performed, and therefore the number of processes may be increased.

As another method, a technology of casting a cylinder block by a die casting method using aluminum alloy and then forming an oxidation film on a surface thereof to secure wear resistance while removing a cylinder liner from the cylinder block has been proposed. However, the method may obtain an effect of reducing the number of processes, but may not sufficiently secure the wear resistance.

Therefore, it is desirable to provide a technology of improving wear resistance of an inner surface of a cylinder while reducing the number of processes by manufacturing a cylinder block of aluminum alloy.

### SUMMARY

An object of the present invention is to provide a method for manufacturing a cylinder block for a vehicle by sintering a cylinder liner molded with powder by integrating the cylinder liner with the cylinder block when the cylinder block is cast.

According to an exemplary embodiment of the present invention, there is provided a method for manufacturing a cylinder block for a vehicle, including: preparing a molded material having a cylinder liner shape; fixing the prepared molded material to an inside of a mold for the cylinder block; and casting the cylinder block integrated with the molded material by injecting casting molten metal for the cylinder block into the mold for the cylinder block to which the molded material is fixed.

According to another exemplary embodiment of the present invention, there is provided a method for manufacturing a cylinder block for a vehicle, including steps of: preparing a molded material having a cylinder liner shape using a raw material powder for a cylinder liner; fixing the prepared molded material to an inside of a mold for the cylinder block; and casting the cylinder block integrated with the molded material by injecting casting molten metal for the cylinder block of Al base into a mold for the cylinder block to which the molded material is fixed, in which the molded material is sintered while the molded material is synthesized with reinforcement by a temperature of the casting molten metal.

In the preparing step, the raw material powder for the cylinder liner may be mixed with Al, TiO₂, and C.

In the casting step, an Al component contained in the casting molten metal for the cylinder block of the Al base may react with the raw material powder forming the molded material to synthesize Al₂O₃ and TiC.

The raw material powder for the cylinder liner may be mixed at a ratio of Al, TiO₂, and C that are 8˜27:2˜4:2˜4 with respect to a mol ratio.

The raw material powder for the cylinder liner may be mixed with 12 to 17 mol of Al with respect to the mol ratio.

The raw material powder for the cylinder liner may be further mixed with 3 to 5 mol of CuO with respect to the mol ratio.

In the casting step, the temperature of the casting molten metal for the cylinder block of the Al base may range from 700 to 1000° C.

In the casting step, the temperature of the casting molten metal for the cylinder block of the Al base may range from 859 to 892° C.

In the preparing step, the molded material having the cylinder liner may be compressed and molded at a pressure of 5000 to 7000 psi.

In the casting step, the casting molten metal for the cylinder block of the Al base may be Al or Al alloy.

### BRIEF DESCRIPTION OF THE DRAWINGS

FIG. 1 is a flow chart illustrating a method for manufacturing a cylinder block for a vehicle according to an exemplary embodiment of the present invention.

FIG. 2 is a graph illustrating DSC analysis results depending on Al addition of a molded material.

FIG. 3 is an XRD graph illustrating a difference in reaction product depending on the Al addition of the molded material.

FIG. 4 is a graph illustrating a change in TiC synthetic temperature depending on the Al addition of the molded material.

FIG. 5 is a graph illustrating DSC analysis results depending on CuO addition of the molded material.

FIG. 6 is a graph illustrating a change in TiC synthetic temperature depending on the CuO addition of the molded material.

FIG. 7 is a graph illustrating the DSC analysis results depending on temperature rising while the temperature of the cylinder block rises.

FIG. 8 is an enlarged graph of region Z from FIG. 7.

FIG. 9 is an XRD graph illustrating a difference in reaction products depending on temperature rising while the temperature of the cylinder block rises.

FIG. 10 is a micro tissue photograph of a part corresponding to a molded material of the cylinder block.

FIG. 11 is a photograph illustrating EPMA analysis results of the part corresponding to the molded material of the cylinder block.

### DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present invention will be described in detail with reference to the accompanying drawings. However, the present invention is not limited to exemplary embodiments disclosed below, but may be implemented in various different forms. These exemplary embodiments will be provided only in order to make the invention of the present invention complete and allow those skilled in the art to completely recognize the scope of the present invention. Throughout the drawings, like reference numerals denote like elements.

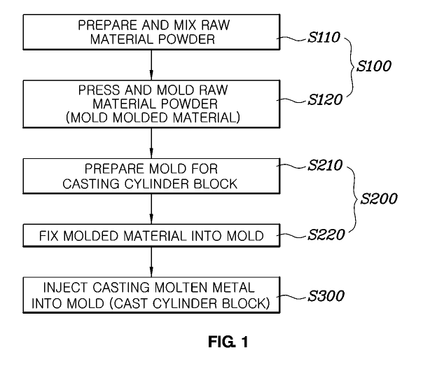

FIG. 1 is a flow chart illustrating a method for manufacturing a cylinder block for a vehicle according to an exemplary embodiment of the present invention.

As illustrated in FIG. 1, a method for manufacturing a cylinder block for a vehicle includes preparing a molded material having a cylinder liner shape (S100), fixing the prepared molded material to an inside of a mold for a cylinder block (S200); and casting the cylinder block integrated with the molded material by injecting casting molten metal for the cylinder block into the mold for the cylinder block to which the molded material is fixed (S300).

The preparing step (S100) is a step of preparing a part serving as the cylinder liner in the cylinder block. Raw material powder for the cylinder liner is prepared and mixed (S110), and then the mixed raw material powder is used to press and mold the molded material having the cylinder liner shape (S120).

In this case, to form reinforcements, the raw material powder for the cylinder liner is mixed after Al, TiO₂, and C are prepared. Further, to lower the formation temperature of the reinforcements, the raw material powder for the cylinder liner may be additionally mixed with the CuO. Further, various raw material powder for forming various reinforcements may be additionally mixed. For example, powder like WO₃ may be additionally mixed.

In this case, for a stoichiometric composition, the raw material powder is preferably mixed at a ratio of Al, TiO₂, and C that are 8˜27:2˜4:2˜4 with respect to a mol ratio. In this case, 12 to 17 mol of Al is preferably mixed with respect to a mol ratio. Further, 3 to 5 mol of CuO is preferably mixed.

However, even though the raw material powder is mixed with respect to the suggested mol ratio, since the raw material powder is not uniformly mixed ideally, the amount of Al which is a base component is insufficient, and therefore the reinforcements of the desired level, for example, Al₂O₃ and TiC are not smoothly synthesized. The desired level (kind, amount) of reinforcements are formed while the insufficient amount of Al is supplemented by Al contained in the casting molten metal for the cylinder block of the Al base provided in the casting step.

If the raw material powder is mixed at the suggested mol ratio, the mixed raw material powder is pressed to be molded in the cylinder liner shape, thereby preparing the molded material. In this case, the molded material having the cylinder liner shape is preferably compressed and molded at a pressure of 5000 to 7000 psi. If the molded material is molded at a pressure less than 5000 psi, the shape of the molded material may be destroyed during the subsequent process and if the molded material is molded at a pressure exceeding 7000 psi, the synthesis of the reinforcements TiC may not be smoothly progressed after the subsequent process is progressed.

If the molded material having the cylinder liner shape is prepared, the mold for casting the cylinder block is prepared (S210) and the prepared molded material is fixed to the inside of the mold for the cylinder block (S220) (fixing step (S200)).

The fixing step (S200) is a preparing step to integrate the molded material having the cylinder liner shape with the cylinder block. In this case, the prepared molded material is charged in and fixed to the inside of mold for casting the cylinder block.

If the fixing of the molded material is completed, the casting molten metal for the cylinder block of the Al base is injected to the mold to cast the cylinder block integrated with the molded material (casting step (S300)). In other words, the casting molten metal for the cylinder block of the Al base, for example, Al or Al alloy is injected into the mold for the cylinder block to which the molded material is fixed, thereby casting the cylinder block integrated with the molded material. Then, the molded material may be sintered while the reinforcements are synthesized (self-propagating high-temperature synthesis reaction) by the temperature of the casting molten metal and the molded material may be integrated with the cylinder block. In this case, the casting of the cylinder block is preferably cast by a die casting method that is a high pressure casting method.

The reason why the casting is performed by the die casting method is that the reinforcements thermodynamically and chemically stabilized are spontaneously synthesized in the molded material by the temperature of the casting molten metal but since the densification of the tissue in the material may be insufficient, products having the densified tissue may be manufactured by controlling the casting pressure during the die casting process. It is confirmed that if the casting pressure is controlled during the die casting process, the Al contained in the casting molten metal is penetrated into the molded material to densify the tissue.

Further, for the use of the die casting method, as the casting molten metal for the cylinder block of the Al base, ADC12 alloy may be used.

Meanwhile, the temperature of the casting molten metal for the cylinder block of the Al base is preferably 700 to 1000° C. that is a general die casting process temperature. In particular, to smoothly form the reinforcements, the temperature of the casting molten metal for the cylinder block of the Al base is preferably limited to 859 to 892° C.

If the die casting is performed while the temperature of the casting molten metal temperature is maintained at the limited temperature, the raw material powder forming the molded material is synthesized by the temperature of the casting molten metal. In particular, various kinds of reinforcements are formed while the aluminum contained in the casting molten metal supplements the amount of aluminum insufficient in the molded material. For example, as the reinforcements, TiAl₃, Cu₂Ti₃, or the like may be formed along with TiC, Al₂O₃, and CuAl₂.

Next, the reason that the mixed ratio of the raw material powder in the present embodiment is limited will be described based on the experiment.

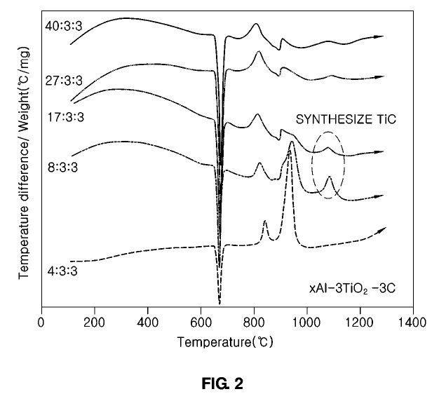

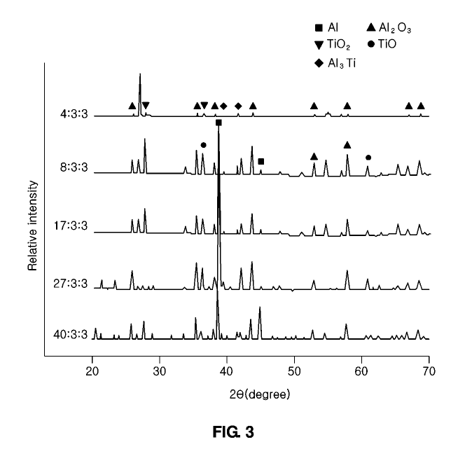

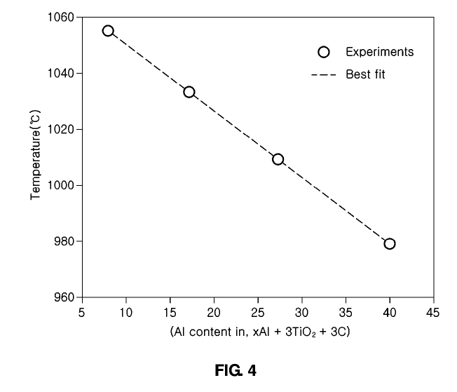

FIG. 2 is a graph illustrating DSC analysis results depending on Al addition of a molded material, FIG. 3 is an XRD graph illustrating a difference in reaction product depending of the Al addition of the molded material, and FIG. 4 is a graph illustrating a change in TiC synthetic temperature depending on the Al addition of the molded material.

In the present experiment, by the experiment to check the synthesis tendency of the reaction products depending on the Al addition, the synthesis tendency of the reaction products was checked while Al, TiO₂, and C are prepared and then the composition ratios of TiO₂ and C are fixed, and then the mixed ratio of Al is controlled (xAl-3TiO₂-3C).

As illustrated in FIGS. 2 and 3, it could be confirmed that TiC is synthesized at the mixed ratio of Al of 8 mol, 17 mol, and 27 mol.

It might be confirmed that the TiC is not synthesized when the mixed ratio of Al is 4 mol.

Since the reaction equation like 4Al+3TiO₂+3C→2Al₂O₃+3Tic is established stoichiometrically but the raw material powder is not uniformly mixed ideally, it might be confirmed that the Al that is the base component is insufficient and therefore the progress of the chemical reaction with surrounding components is not smoothly progressed.

Further, it might be confirmed that the TiC is synthesized when the mixed ratio of Al is 40 mol but is not synthesized to the desired level.

Therefore, with respect to the mol ratio of Al in the raw material powder forming the molded material for the TiC synthesis, preferably, 8 to 27 mol of Al is mixed and more preferably, 12 to 17 mol of Al is mixed.

Meanwhile, as illustrated in FIG. 4, it might be confirmed that as the amount of Al is increased, the synthesis temperature of TiC tends to be reduced.

Therefore, as illustrated in FIGS. 2 to 4, it might be confirmed that to supplement the Al for the TiC synthesis, the die casting process using the casting molten metal of the Al base is required and the synthesis temperature of TiC may be reduced by controlling the amount of Al. In particular, it might be confirmed that the die casting process may be performed by controlling the amount of Al to control the temperature of the casting molten metal to be 700 to 1000° C. that is the general die casting process temperature.

Next, the experiment to check the synthesis tendency of reaction products depending on the mixed ratio of auxiliary components was performed.

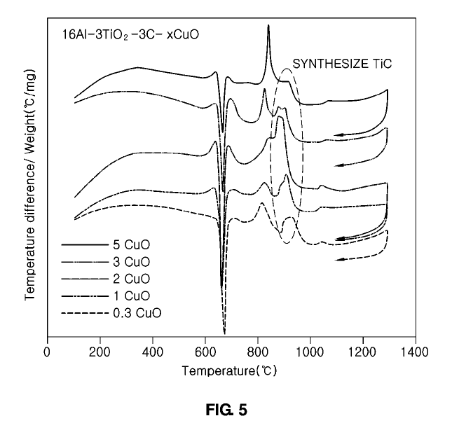

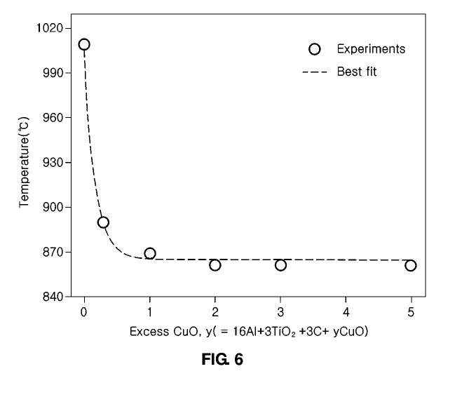

FIG. 5 is a graph illustrating DSC analysis results depending on CuO addition of the molded material, and FIG. 6 is a graph illustrating a change in TiC synthetic temperature depending on the CuO addition of the molded material.

The present experiment is to check the synthetic tendency of the reaction products depending on CuO addition that is an auxiliary component for adding Cu to improve the material characteristics within the base. In the present experiment, the synthesis tendency of the reaction products was checked while Al, TiO₂, C, and CuO are prepared, the composition ratios of Al, TiO₂ and C are fixed, and the mixed ratio of CuO is controlled (16Al-3TiO₂-3C-xCuO).

As illustrated in FIG. 5, it could be confirmed that the larger the mixed ratio of CuO, the larger the volume fraction of TiC. However, it could be confirmed that when the mixed ratio of CuO is low, the TiC is not formed as much as the desired level.

Further, as illustrated in FIG. 6, it was confirmed that the TiC synthetic temperature is reduced by the mixing of CuO and the larger the mixed ratio of CuO, the lower the synthetic temperature of TiC.

Therefore, it is preferable that the mixed ratio of CuO is 3 to 5 mol with respect to a mol ratio.

Next, the experiment for checking the synthetic tendency of the reaction products depending on the temperature with respect to the cylinder block integrated with the molded material manufactured according to the present invention was performed.

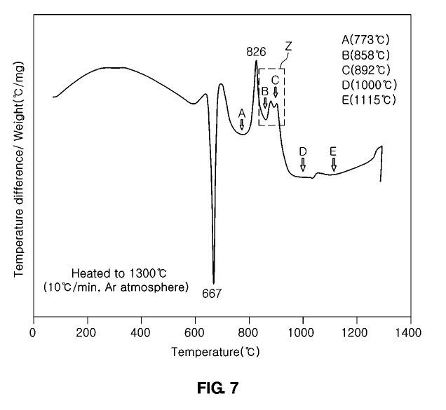

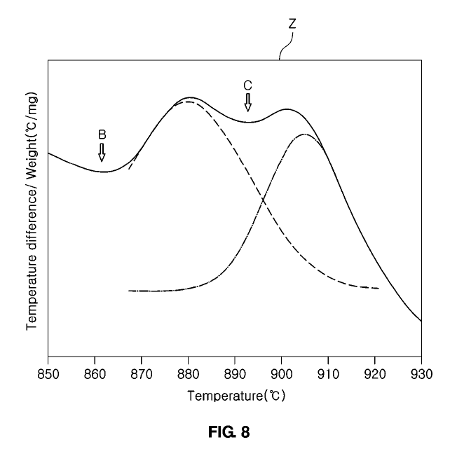

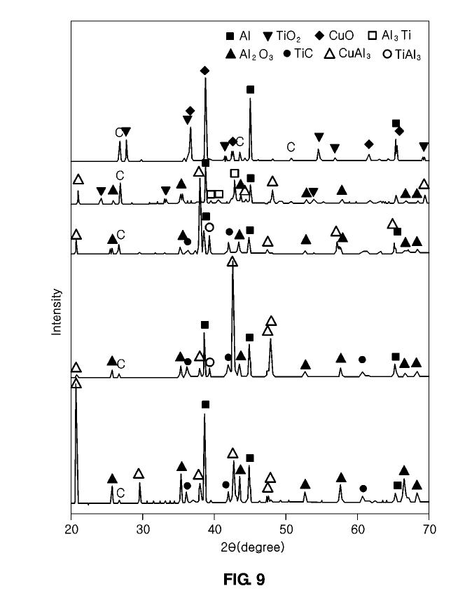

FIGS. 7 and 8 represent a graph illustrating the DSC analysis results depending on temperature rising while the temperature of the cylinder block rises, and FIG. 9 is an XRD graph illustrating a difference in reaction products depending on temperature rising while the temperature of the cylinder block rises.

The present experiment is to check the synthetic tendency of the reaction products with the molded material depending on the temperature in the state in which Al is sufficiently supplied. In the present experiment, the molded material was manufactured in the state in which Al, TiO₂, C, and CuO are prepared and then the mixed ratio is fixed (17Al-3TiO₂-3C-3CuO) and the synthetic tendency of reaction products was checked while the temperature rises to 10° C./min under Ar atmosphere for products on which the die casting process is performed to additionally supply Al. In this case, FIG. 9 is an XRD analysis result at each point illustrated in FIGS. 7 and 8.

As illustrated in FIGS. 7 to 9, it could be confirmed that the TiC is synthesized at point C and point D but it could be confirmed that the TiC is not synthesized at point A and point D. The more detailed synthesis tendency of the reaction products was shown as in the following Table 1.

TABLE 1

| | | Increase | Decrease |
|---|---|---|---|
| | Newly synthesis | of X-ray | of X-ray |
| | phase | intensity | intensity |
| B (774~858° C.) | CuAl₂, Al₂O₃, Cu₂Ti₃ | | |
| C (859~892° C.) | TiC, TiAl₃ | CuAl₂, Al₂O₃ | Cu₂Ti₃ |
| D (893~999° C.) | | TiC, CuAl₂, Al₂O₃ | TiAl₃ |
| E (1000~1114° C.) | | CuAl₂, Al₂O₃ | |

Therefore, the temperature of the casting molten metal is preferably limited to 700 to 1000° C. for the smooth synthesis of reinforcements and the temperature of the casting molten metal is more preferably limited to 859 to 892° C. for the smooth synthesis of TiC.

Next, the micro tissue photograph of the cylinder block integrated with the molded material manufactured according to the present invention was analyzed.

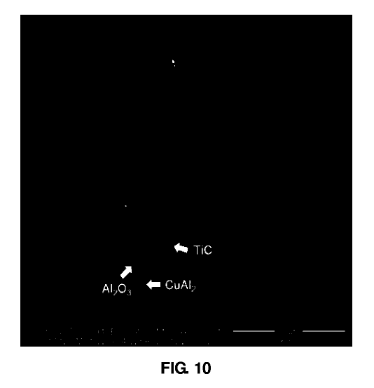

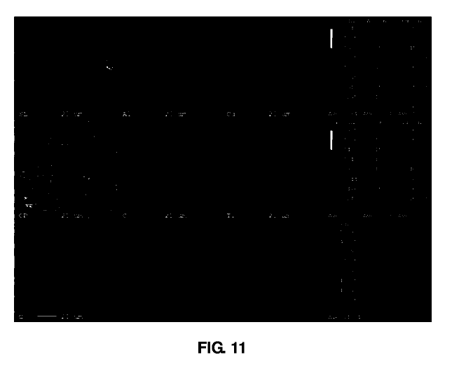

FIG. 10 is a micro tissue photograph of a part corresponding to a molded material of the cylinder block, and FIG. 11 is a photograph illustrating EPMA analysis results of the part corresponding to the molded material of the cylinder block.

The molded material illustrated in FIGS. 10 and 11 was manufactured at the mixed ratio of 17Al-3TiO₂-3C-3CuO and FIGS. 10 and 11 illustrate the micro tissue photograph and the EPMA analysis result for the products on which the die casting process is performed to supply the additional supply of Al.

As illustrated in FIGS. 10 and 11, it could be confirmed that TiC is uniformly generated around CuAl₂ and the densified structure is formed without a material having pores on the whole.

According to the exemplary embodiments of the present invention, it is possible to manufacture the cylinder block integrated with the molded body having the cylinder liner shape by injecting the casting molten metal for the cylinder block into the mold in the state in which the molded material having the cylinder liner shape molded with the raw material in the powder state is charged in the mold.

Therefore, it is possible to reduce the number of manufacturing processes of the cylinder block.

Further, it is possible to manufacture the cylinder block having the improved wear resistance by sintering the molded material at a molten metal temperature.

Further, it is possible to improve the wear resistance of the cylinder block by forming the reinforcements such as Al₂O₃ and TiC by controlling the kind of raw material powders and the composition ratio forming the molded material.

The present invention is described with reference to the accompanying drawings and the foregoing exemplary embodiments but is not limited thereto and is limited by the following claims. The present invention may be variously changed and modified by those skilled in the art without departing from the technical sprit of claims to be described below.

What is claimed is:

1. A method for manufacturing a cylinder block for a vehicle, comprising the steps of:
preparing a molded material having a cylinder liner shape;
fixing the prepared molded material to an inside of a mold for the cylinder block; and
casting the cylinder block integrated with the molded material by injecting casting molten metal for the cylinder block into the mold for the cylinder block to which the molded material is fixed.

2. A method for manufacturing a cylinder block for a vehicle, comprising the steps of:
preparing a molded material having a cylinder liner shape using a raw material powder for a cylinder liner;
fixing the prepared molded material to an inside of a mold for the cylinder block; and
casting the cylinder block integrated with the molded material by injecting casting molten metal for the cylinder block of Al base into the mold for the cylinder block to which the molded material is fixed, in which the molded material is sintered while the molded material is synthesized with reinforcement by a temperature of the casting molten metal.

3. The method of claim 2, wherein in the preparing step, the raw material powder for the cylinder liner is mixed with Al, TiO₂, and C.

4. The method of claim 3, wherein in the casting step, an Al component contained in the casting molten metal for the cylinder block of the Al base reacts with a raw material powder forming the molded material to synthesize Al₂O₃ and TiC.

5. The method of claim 3, wherein the raw material powder for the cylinder liner is mixed at a ratio of Al, TiO₂, and C that are 8˜27:2˜4:2˜4 with respect to a mol ratio.

6. The method of claim 5, wherein the raw material powder for the cylinder liner is mixed with 12 to 17 mol of Al with respect to the mol ratio.

7. The method of claim 5, wherein the raw material powder for the cylinder liner is further mixed with 3 to 5 mol of CuO with respect to the mol ratio.

8. The method of claim 6, wherein the raw material powder for the cylinder liner is further mixed with 3 to 5 mol of CuO with respect to the mol ratio.

9. The method of claim 2, wherein in the casting step, the temperature of the casting molten metal for the cylinder block of the Al base ranges from 700 to 1000° C.

10. The method of claim 9, wherein in the casting step, the temperature of the casting molten metal for the cylinder block of the Al base ranges from 859 to 892° C.

11. The method of claim 2, wherein in the preparing step, the molded material having the cylinder liner is compressed and molded at a pressure of 5000 to 7000 psi.

12. The method of claim 2, wherein in the casting step, the casting molten metal for the cylinder block of the Al base is Al or Al alloy.
